(19) United States
(12) Patent Application Publication
(10) Pub. No.: US 2019/0145532 A1
(43) Pub. Date: May 16, 2019

(54) ADJUSTMENT TOOL FOR PRESSURIZED VESSELS

(71) Applicant: OIL STATES INDUSTRIES, INC., Arlington, TX (US)

(72) Inventors: Jason F. Hill, Pearland, TX (US); Robert Michael Kilpatrick, Cleveland, TX (US)

(73) Assignee: OIL STATES INDUSTRIES, INC., Arlington, TX (US)

(21) Appl. No.: 16/192,600

(22) Filed: Nov. 15, 2018

Related U.S. Application Data
(60) Provisional application No. 62/586,748, filed on Nov. 15, 2017.

(51) Int. Cl. F16K 11/076; F17C 13/04

(52) U.S. Cl. CPC F16K 11/076; F17C 2205/0338; F17C 13/04

(57) ABSTRACT

An adjustment tool for a multiport valve including an elongate frame having a fitted end with an exit aperture, a pressure chamber in fluidic communication with the exit aperture, the fitting end sealingly couplable with the multiport valve to form sealed fluidic communication between the multiport valve and the pressure chamber through the exit aperture, a pressure valve actuable to open and close fluid flow from the pressure chamber to outside the frame, a bore. An elongate stabbing body is slidable and rotatable within the bore and having an adjustment end, the elongate stabbing body slidable within the bore from a first unactuated configuration where the adjustment end and is contained within the pressure chamber through the exit aperture to a second projected configuration wherein the adjustment end is extended outside the elongate frame and into the multiport valve when the fitted end is coupled with the multiport valve.

### CROSS-REFERENCE TO RELATED APPLICATIONS

The present application claims the benefit of U.S. Provisional Application No. 62/586,748 filed Nov. 15, 2017, which is hereby incorporated by reference in its entirety.

### FIELD

The present disclosure relates to an adjustment tool for pressurized vessels, and in particular to adjustment tools for multiport valves in an oil and gas field environment.

### BACKGROUND

Multiport valves are employed in oil and gas applications for facilitating production flow from a plurality of wells while facilitating diversion of a test flow. In particular, multiport valves permit the selection of one inlet from among a number of inlets (such as eight) so as to divert the flow from the selected inlet to an outlet for testing. The flow from the remaining inlets is gathered to a common outlet for the group. In this way fluid from one individual well can be diverted for testing without disrupting the flow from the remaining wells. Such multiport valves may be used in other fields such as water treatment, waste water plants and irrigation, wherever multiple inlet flows may be combined to a common flow, with one exit line for testing. Various tools can be employed for adjusting internal and external components of the multiport valves as needed.

### BRIEF DESCRIPTION OF THE DRAWINGS

In order to describe the manner in which the advantages and features of the disclosure can be obtained, reference is made to examples thereof which are illustrated in the appended drawings. Understanding that these drawings depict only examples of the disclosure and are not therefore to be considered to be limiting of its scope, the principles herein are described and explained with additional specificity and detail through the use of the accompanying drawings in which:

FIG. 1 is a multiport valve system according to an example of the present disclosure;

FIG. 2A is an example multiport valve according to an example of the present disclosure;

FIG. 2B is a diagram of a multiport valve according to an example of the present disclosure;

FIG. 2C is a diagram of an exploded portseal assembly according to an example of the present disclosure;

FIG. 2D is a diagram of a stabbable tool and a multiport valve according to an example of the present disclosure;

FIG. 2E is a simplified view of the front of a stabbable tool engaged with a portseal assembly according to an example of the present disclosure;

FIG. 3 is a stabbable tool for adjustment of a multiport valve according to an example of the present disclosure;

FIG. 4 is a diagram of a stabbable tool according to an example of the present disclosure;

FIG. 5A is a partial cross-sectional view of the front end of a stabbable tool according to an example of the present disclosure;

FIG. 5B is a partial cross-sectional view of the rear end of a stabbable tool according to an example of the present disclosure;

FIG. 6A is a top plan view of a stabbable tool according to an example of the present disclosure;

FIG. 6B is perspective view of a stabbable tool according to an example of the present disclosure;

FIG. 6C is perspective view of a stabbable tool in an aunactuated configuration according to an example of the present disclosure;

FIG. 6D is front view of a stabbable tool in a projected configuration according to an example of the present disclosure;

FIG. 7A is a stabbable tool with an elongate stabbing body in a projected configuration according to an example of the present disclosure;

FIG. 7B is a stabbable tool with an elongate stabbing body in a projected configuration according to an example of the present disclosure; and

FIG. 8 is a stabbable tool coupled with a multiport valve according to an example of the present disclosure.

### DETAILED DESCRIPTION

Various examples of the disclosure are discussed in detail below. While specific implementations are discussed, it should be understood that this is done for illustration purposes only. A person skilled in the relevant art will recognize that other components and configurations may be used without parting from the spirit and scope of the disclosure.

It should be understood at the outset that although illustrative implementations of one or more examples are illustrated below, the disclosed compositions and methods may be implemented using any number of techniques. The disclosure should in no way be limited to the illustrative implementations, drawings, and techniques illustrated herein, but may be modified within the scope of the appended claims along with their full scope of equivalents.

In the following discussion and in the claims, the terms “including” and “comprising” are used in an open-ended fashion, and thus should be interpreted to mean “including, but not limited to . . . ”. The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “approximately” is defined as near or approaching a certain state, condition, goal, or standard. The term “about” is defined to be near or close and can refer to either a numerical value or distance away from a specified object.

As oil fields may have a number of wellbores which may be located a distance away from each other, production from each of the wellbores may be transported to a central gathering station. Multiport valves may be employed to receive production flow from a plurality of wells to a common outflow production line. In one example, the multiport valve may have a diversion line for separating one of the flows to a separate test outlet. Accordingly, a plurality of inlets are gathered to a common outlet, while any one of the individual inlets may be diverted to a separate outlet for testing. A portseal provides isolation between the test flow and the group flow. In order to maintain a positive seal, the portseal is energized by a biasing device as such as a spring. The portsteal has a tendency to wear against the interior surface of the valve, causing the spring to lose a pre-load. In order to prevent the test flow from leaking into and contaminating the group flow or vice versa, operators may tighten an adjustment nut to renew the spring preload. The adjustment nut may be accessed through at least one of the inlets (the designated inlet may be referred to as the home port) using the tool disclosed herein. While previously the valve had to be entirely shut in and depressurized to service the adjustment nut, the stabbable tool disclosed herein permits adjustment in pressurized and depressurized valves. The stabbable tool disclosed herein is not limited to the multiport valve described herein but may be equally employed with other valves or any pressure vessels.

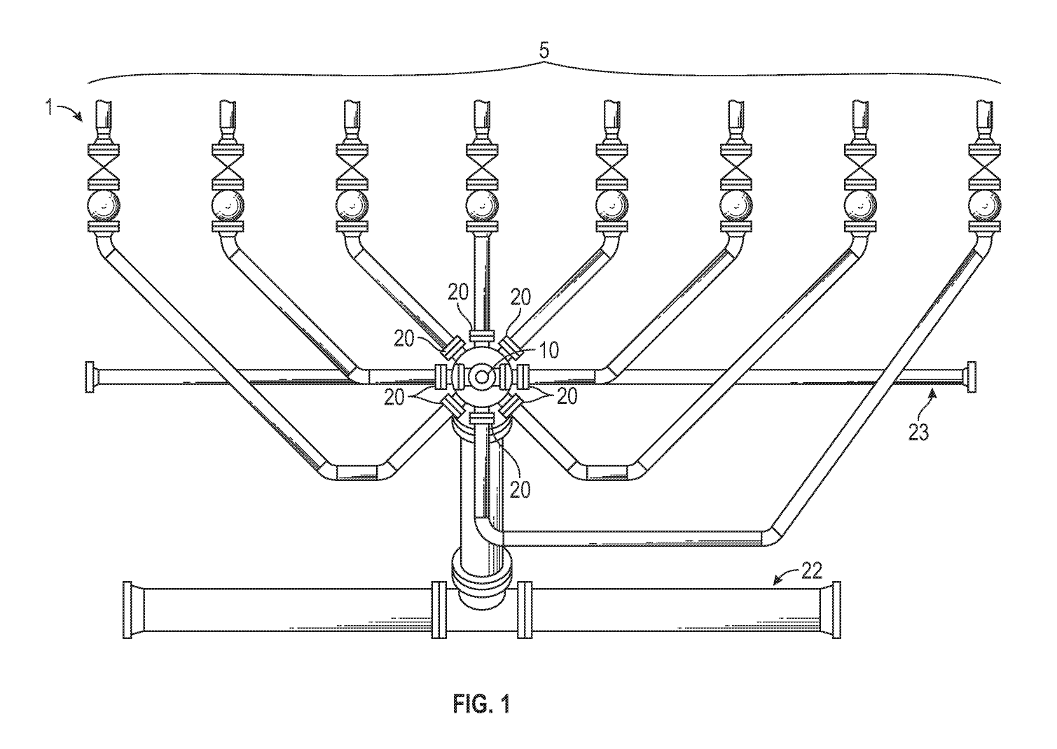

An example multiport valve system 1 is illustrated in FIG. 1. In this system, production lines 5 are fed from various wellbores (not shown) to inlets 20 of the multiport valve 10. While eight (8) production lines 5 are shown in FIG. 1, any number of production lines may be fed to a corresponding number of inlets 20 of the multiport valve 10. In one example, the number of production lines can be from 2 to 16, 4 to 10, or 6-8, or any other suitable number of production lines 5 and corresponding number of inlets 20. The number of inlets 20 may depend on various factors including the efficiency and amount of production for channeling to a common flow. The inlets 20 are combined and channeled to a combined production outflow line 22. The multiport valve 10 may also divert one of the inlets 20 to a test outflow line 23.

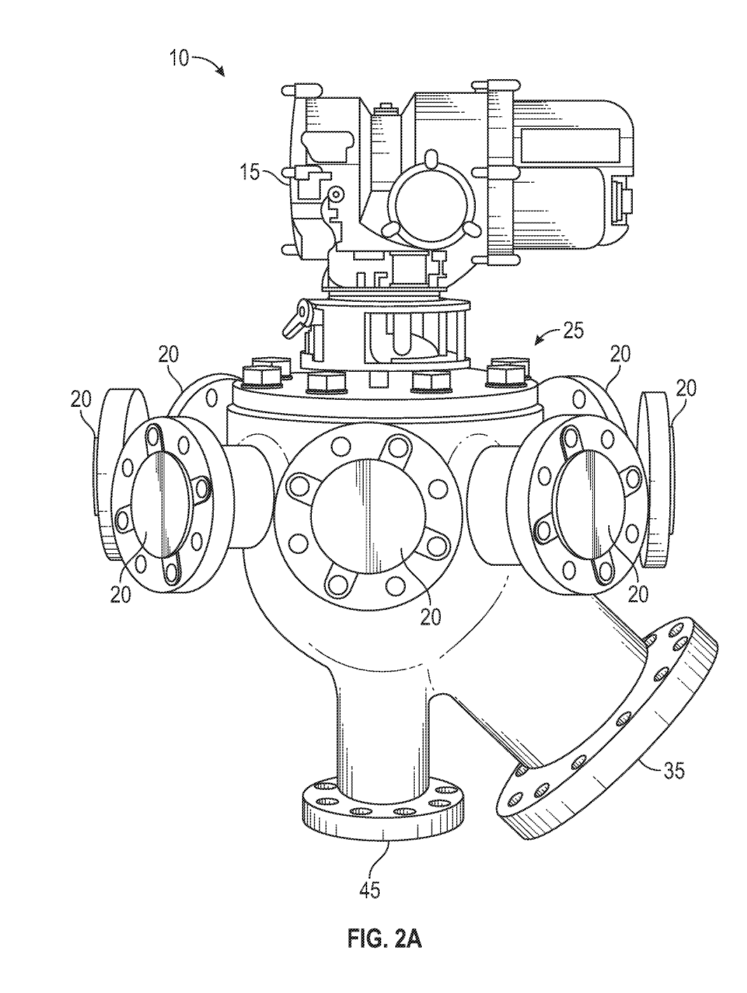

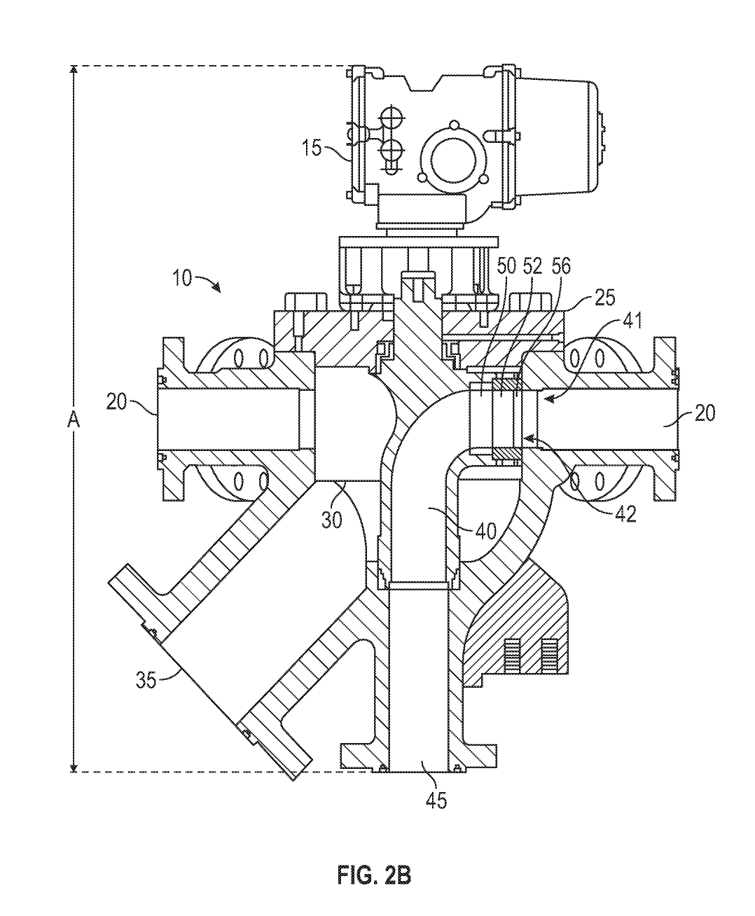

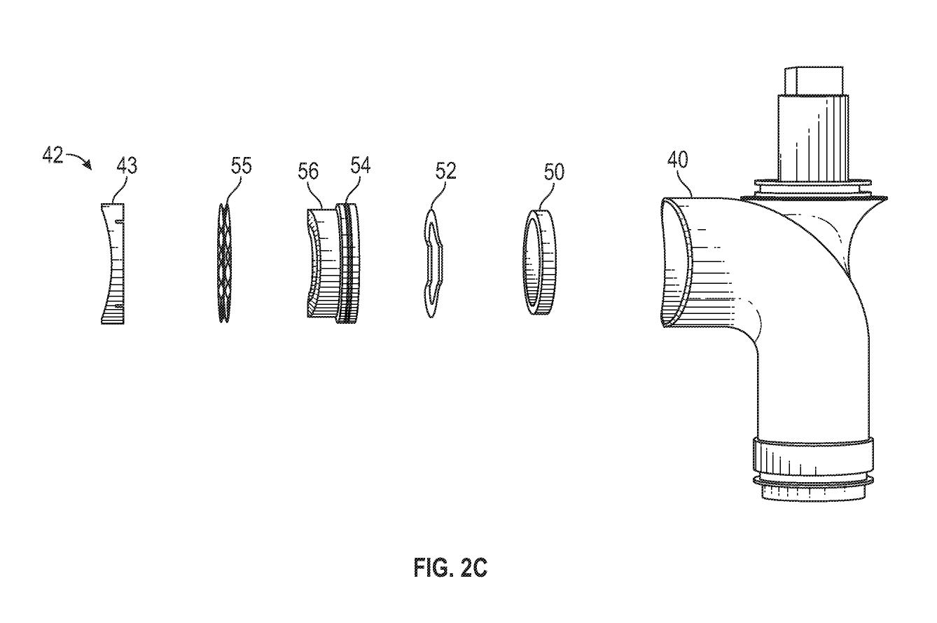

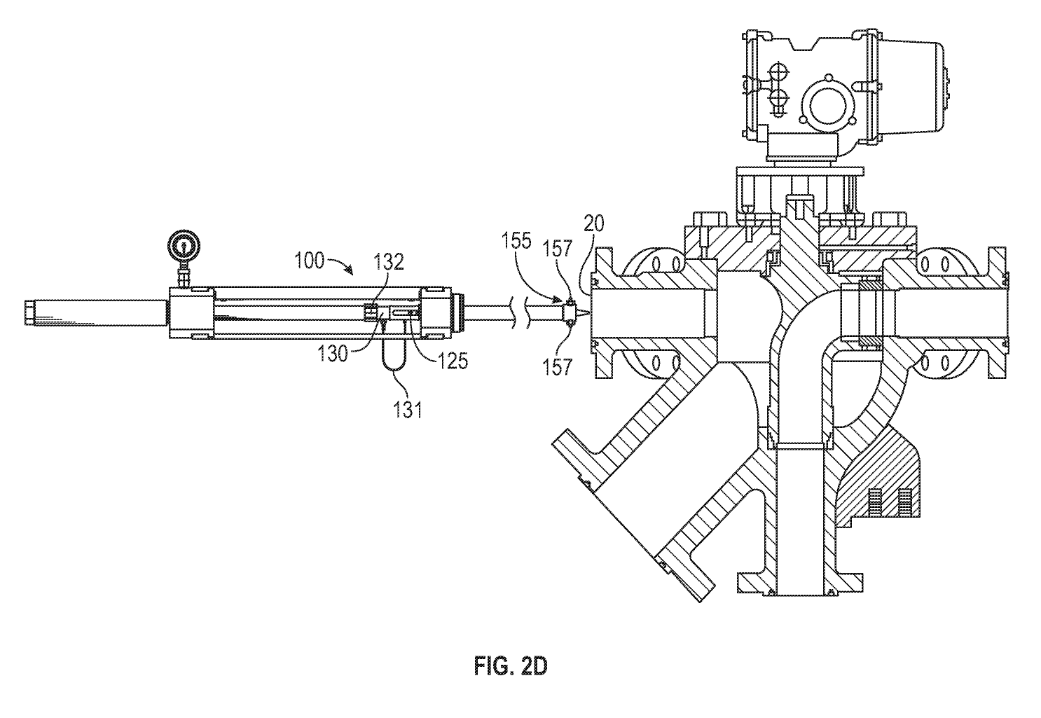

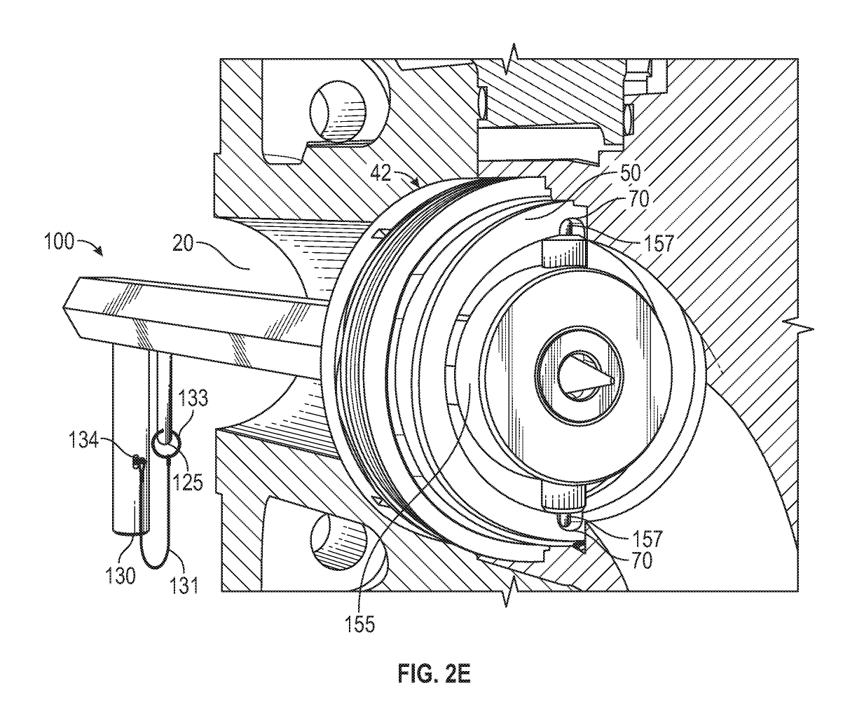

FIGS. 2A and 2B illustrate the example multiport valve 10 of FIG. 1, with FIG. 2B being a sectional view. As shown in FIG. 2A, the plurality of inlets 20 (having covers) are spaced radially about the circumference of body 25 of the multiport valve 10. The multiport valve body 25 can be made of a durable material, such as carbon steel or other high strength iron, to handle harsh oil field environments and may be abrasion resistant. The multiport valve body 25 can also be made of any suitable material(s) or coated with material(s) having properties suitable to withstand harsh oilfield environments. The inlets 20 feed to an internal common bore 30 (shown in FIG. 2B) which is fed to common outlet 35. The common outlet 35 may be fluidically coupled with the production outflow line 22 (shown in FIG. 1). The coupling, as well as all couplings herein unless otherwise noted, can be made by any connection to form a sealed coupling, such as threaded, bolted, and/or flanged along with seals (such as O-ring seals). The internal inlet port selector rotor 40 is rotatable within the multiport valve body 25 to select one of the plurality of inlets 20 to bypass and divert to test outlet 45. Accordingly, a production fluid may enter the inlet 20 and pass into the rotor mouth 41 of the inlet port selector rotor 40. Then, the production fluid may flow to a test outlet 45 and thereafter to test outflow line 23 (shown in FIG. 1). The multiport valve 10 may additionally include an actuator 15 coupled to the top of the multiport valve 10. The actuator 15 may be any type of device operable to rotate the inlet port selector rotor 40 within the interior of the body 25. Any conventional means for actuating may be employed including, alternating current (“AC”) or direct current (“DC”) powered micro-switch or light emitting diode (“LED”) optical encoder. Alternatively, or additionally, the inlet port selector rotor 40 may be rotated manually.

The inlet port selector rotor 40 at a rotor mouth 41 has a portseal assembly 42 provided to prevent leakage between the test flow from inlet 20 and inlet port selector rotor 40 and the group flow in common bore 30. To maintain a positive seal, the portseal assembly 42 has a portseal 56 which is energized by a spring 52. An adjustment nut 50 is rotated to renew the preload on the spring 52. An exploded diagram of the portseal assembly 42 is provided in FIG. 2C. As shown therein the portseal assembly 42 has an adjustment nut 50, a spring 52 (illustrated as a single turn wave spring), a port seal O-ring 54, the portseal 56, a scraper spring 55 (illustrated as a double-turn wave spring), and a scraper 43. As the portseal 56 wears against the interior surface of the bore 30 (shown in FIG. 2B), the spring 52 loses its preload. The adjustment nut 50, upon rotation, increases the pre-load on the portseal 56 by pushing and urging against the spring 52. The port seal O-ring 54 forms a seal on the internal surface of the rotor 40 when the portseal 56 is installed. The scraper spring 55 pushes and urges the scraper 43 against the internal surface of the bore 30 (FIG. 2B) so as to keep the area clean for the portseal 56 to form a seal. The scraper 43 may be made of aluminum or other metal. The preload may be a force that the spring 52 exerts against the portseal 56 to allow for desired operation of the multiport valve 10. The preload for a 2″ multiport valve may be from about 10 to about 50 ft/lbs, alternatively from about 20 to about 40 ft/lbs. Furthermore, although wave springs are shown, it is within the scope of this disclosure to implement single or multi-wave springs or any type of spring, such as leaf spring, coiled spring, or any other biasing element, or elastic material.

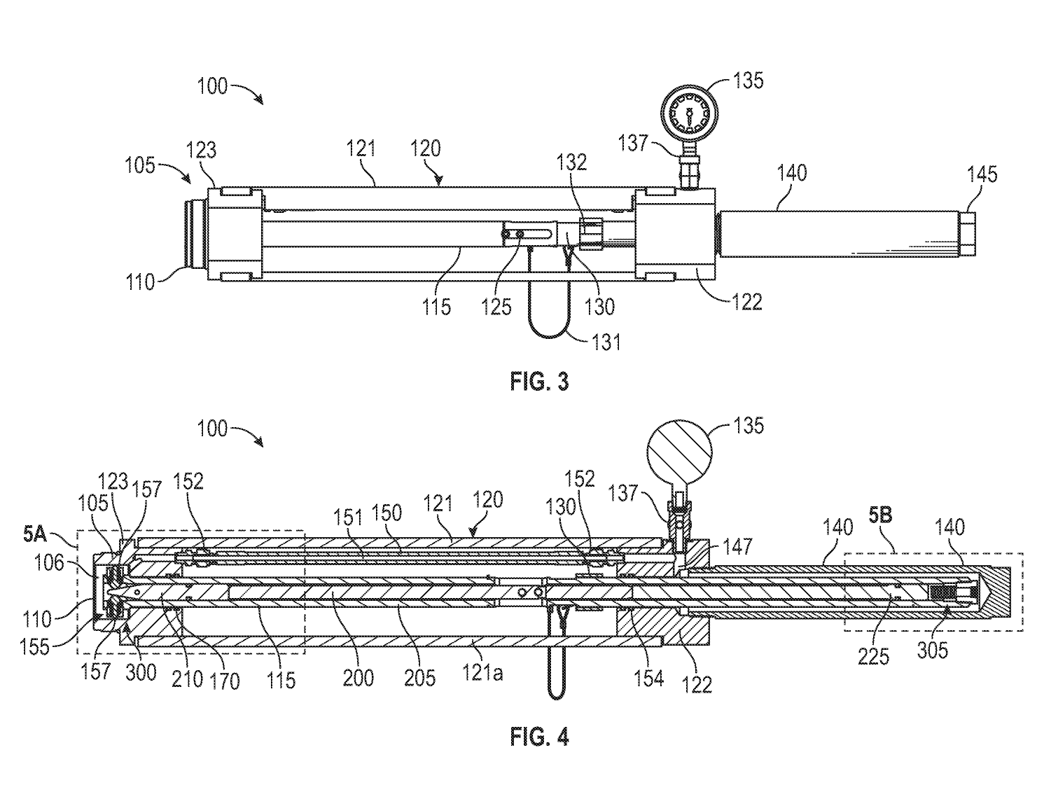

In order to counter the loss of a preload of the spring 52, the adjustment nut 50 may be tightened in order to renew the spring preload. The one or more inlets 20 of the multiport valve 10 may, individually, provide access to the stabbable tool 100 to the adjustment nut 50. If one of the one or more inlets 20 is designated to be used to renew the spring preload it may be referred to in the field as the “home port.” Alternatively, a single one of the one or more inlets 20 can be designed as and referred to in the field as the home port. In order to tighten the spring 52, a stabbable tool 100 as shown in FIG. 2D may be employed. As shown in FIG. 2D, the stabbable tool 100 has a handle 130 and a trigger 125 along with hex portion 132. A lanyard 131 may extend from the handle 130 to the trigger 125 via a projection 134 on the handle 130 and a ring 133 on trigger 125. This permits the trigger 125 to hang from handle 130 when not in use, and avoid becoming lost. The adjustment end 155 has pins 157 which may be retracted by an operator by actuating the trigger 125. The trigger 125 may be actuated by moving the trigger 125 toward the handle 130 (other actuation mechanisms may also be employed). FIG. 2E illustrates a simplified view of the engagement of the adjustment end 155 of the stabbable tool 100 with the adjustment nut 50, so as to better show how the pins 157 engage the adjustment nut 50, whereas more detailed diagrams of the stabbable tool 100 and coupling with the multiport valve 10 are provided in FIGS. 3-8. As illustrated in FIG. 2E, upon actuating the trigger 125 to retract pins 157, the adjustment end 155 of the stabbable tool 100 may be inserted into the inlet 20 to engage the adjustment nut 50 of the portseal assembly 42 as illustrated in FIG. 2E. The trigger 125 may then be released thereby extending pins 157 and positioned within the indents 70 of the adjustment nut 50. The stabbable tool 100 is then rotated to correspondingly rotate the adjustment nut 50 which compresses the portseal assembly 42 thereby renewing the spring preloads of the springs (such as spring 55 and/or single wave spring 52) in the assembly.

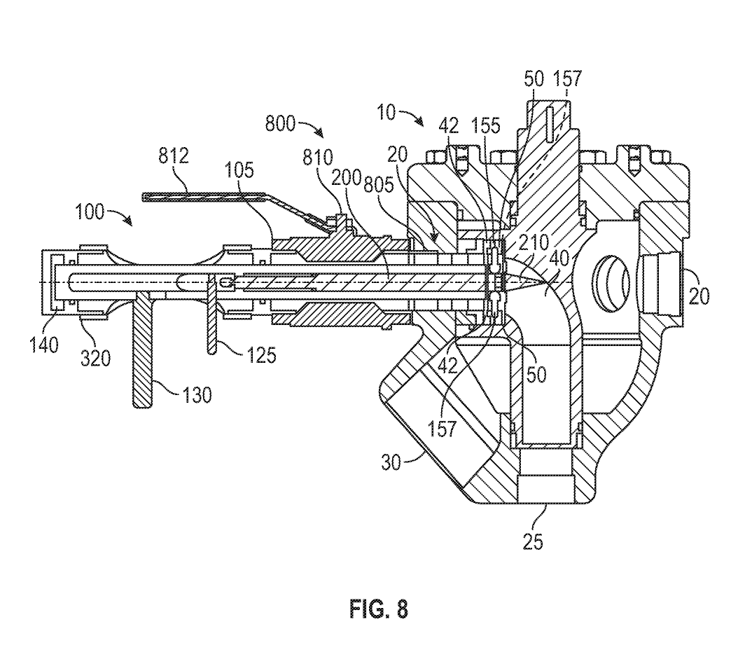

While the stabbable tool 100 is depicted in FIG. 2E in simplified form, it is described in more detailed with respect to FIGS. 3-7B. Additionally, the stabbable tool 100 is further illustrated in FIG. 8 below showing the interaction with the multiport valve 10 to maintain a seal with the multiport valve 10.

An example of stabbable tool 100 for adjustment of the multiport valve 10 is illustrated FIG. 3. As shown the stabbable tool 100 includes a frame 120. The frame 120 may have a support bar 121 extending between a distal coupling body 122 and proximal coupling body 123. The proximal coupling body 123 may have a fitted end 105. The fitted end 105 may be coupled with an inlet 20 of the multiport valve 10 via a valve (namely, ball valve 810 shown in FIG. 8). The fitted end 105 has narrower external diameter than the proximal coupling body 123 such that the proximal coupling body 123 may form a shoulder abutting the ball valve 810 of the multiport valve 10 when the fitted end 105 is coupled to an inlet 20. The fitted end 105 may be threaded (SAE as shown or alternatively may be NPT) and may couple with the inlets 20 via a valve (namely, ball valve 810 shown in FIG. 8 below) which may be correspondingly threaded to receive the fitted end 105. The fitted end 105 additionally has an exit aperture 110 so as to provide fluidic communication between the multiport valve 10 and the stabbable tool 100 (for example the pressure chamber 147 of the stabbable tool 100 discussed with reference to FIG. 4). The frame 120 further has a valve 137 which may be a ball valve which may be open to vent a fluid (liquid or gas) contained in the pressure chamber 147 within the frame 120 as well as a pressure gage 135 to indicate pressure. A pressure gage 135 can be provided to indicate pressure within the stabbable tool 100 as well as inlet 20 of the multiport valve 10. While the illustrated pressure gage 135 is an analog pressure gage, the pressure gage 135 can be implemented as a digital pressure gage. In other examples, the pressure can be remotely monitored either alone or in conjunction with a local pressure gage 135. Based on the pressure at the pressure gage 135 the user can determine the engagement of the stabbable tool with the multiport valve 10.

A pressure compensation cylinder 140 may be coupled with the distal coupling body 122 having an extended cylinder end 145 and/or may have an end cap which may be rotated on the distal coupling body. The stabbable tool 100 has an elongate stabbing body 115 slidable within the frame 120 and extending between the proximal coupling body 123 and distal coupling body 122 and having handle 130. A trigger 125 is provided adjacent the handle 130 to adjust the adjustment end 155 (shown in FIG. 4) the elongate stabbing body 115.

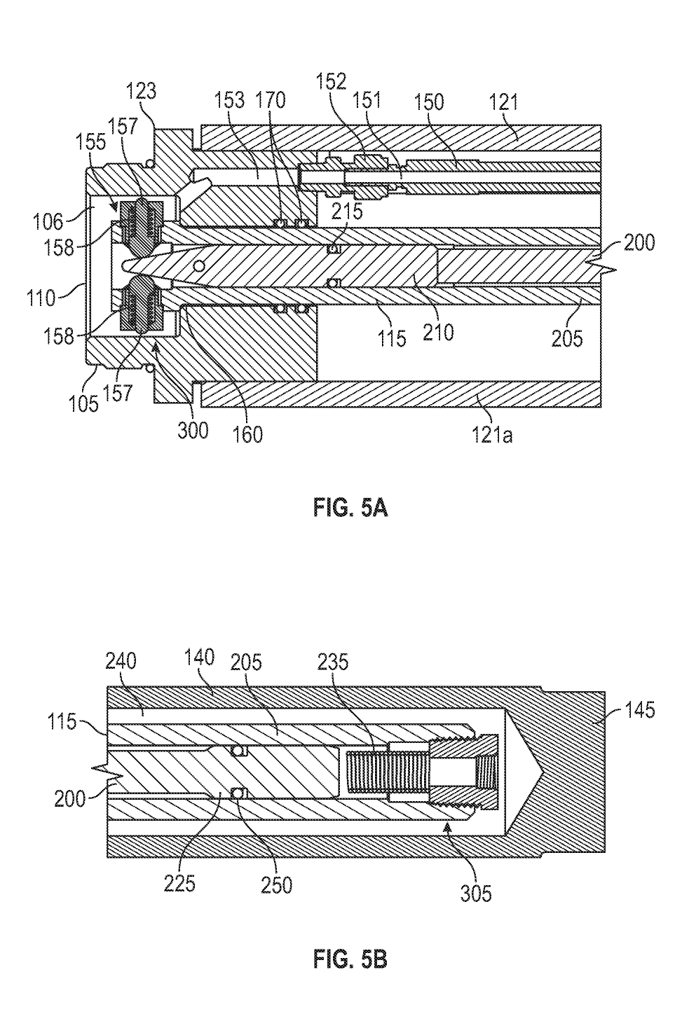

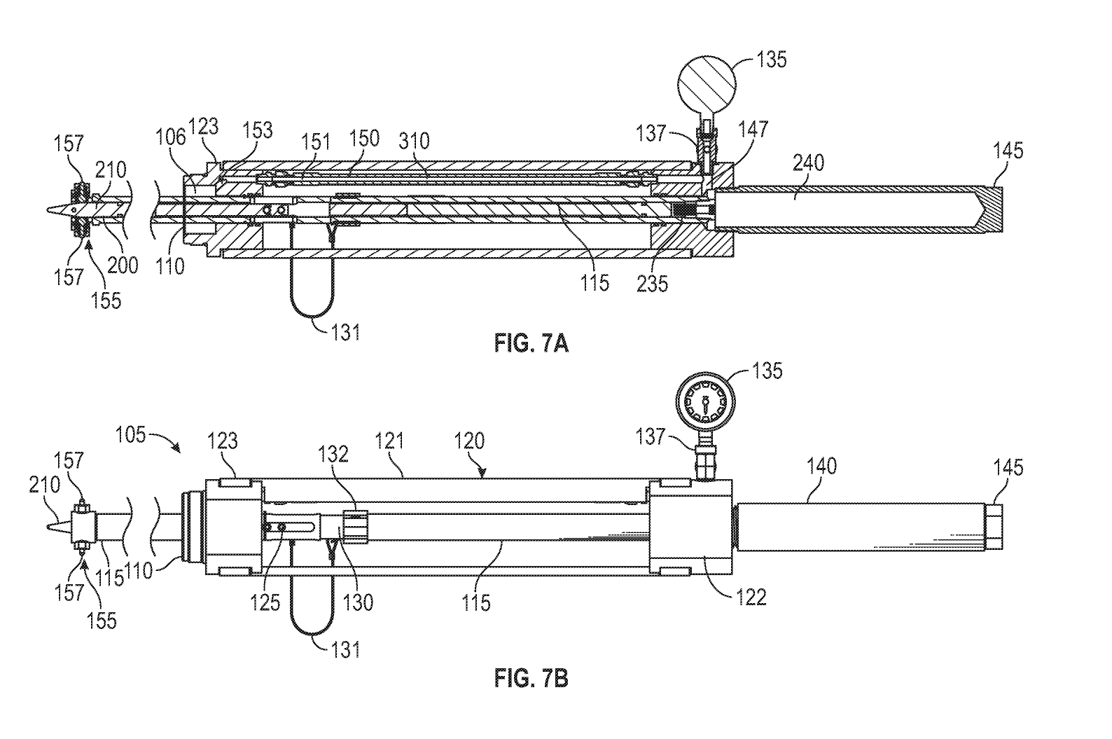

A sectional view illustrating the internal components of the stabbable tool 100 is illustrated in FIG. 4. The stabbable tool 100 in FIG. 4 is substantially the same as that in FIG. 3, except that a lower support bar 121a is illustrated. As shown in FIG. 4, the valve 137 provides a passage from outside the frame 120 to the pressure chamber 147 of the stabbable tool 100. The pressure chamber 147 extends fluidic communication throughout the length of the frame 120 providing a chamber for containing fluid (gas or liquid) at pressure (shown in more detail in FIG. 7A), extending through and including a bore 151 of hydraulic hose 150, the pressure chamber mouth 106, and the cavity 240 (see FIG. 5B) in the pressure compensation cylinder 140. The pressure chamber 147 is in fluidic communication with the exit aperture 110. The hydraulic hose 150 (or any pipe or tubular) may have hydraulic fittings 152 on both ends or may be threaded on both ends (and therefore may be a nipple pipe), and couples with the proximal coupling body 123 and distal coupling body 122 which has a dual O-rings 154 to provide a seal (which may be a single O-ring or other plurality of O-rings or other sealing arrangement). When attached, the pressure chamber 147 additionally extends to within the pressure compensation cylinder 140. As described above, an operator may use ball valve 137 to vent and/or control the pressure within pressure chamber 147. The ball valve 137 may be employed to vent pressure within the pressure chamber 147 after use or to equalize pressure between the multiport valve 10 and the pressure chamber 147 to advance the elongate stabbing body 115, which will be further described below. Furthermore, an operator can view and control the pressure of the pressure chamber 147 via the pressure gage 135.

As illustrated in FIG. 4, the elongate stabbing body 115 has a plunger 200, or piston, within an outer tubular wall 205. The elongate stabbing body 115 has a proximal end 300 having the adjustment end 155, as well as a distal end 305 opposite the proximal end 300. FIG. 5A illustrates a partial cross-sectional view of the front end of the stabbable tool 100 of FIG. 4. As illustrated the elongate stabbing body 115 extends through a bore 160 of the proximal coupling body 123. The bore 160 may optionally have a bushing providing support to the elongate stabbing body 115. A seal 170, which may be dual O-rings as shown, or may be a single O-ring or a plurality, or other sealing arrangement, is also provided in the bore 160 around the elongate stabbing body 115 to prevent leakage and fluid flow from the pressure chamber mouth 106 of any fluid contained in the pressure chamber mouth 106. The plunger 200 has a plunger head 210 having a seal 215 within the outer tubular wall 205, and which may also be placed within a bushing. The plunger head 210 may be a separate component and attached via male and female thread to the body of the plunger 200 or may be integral therewith. At the proximal end 300 of the elongate stabbing body 115, the adjustment end 155 has pins 157 which are shown in a retracted position but may be extended laterally relative to the elongate stabbing body 115 via actuation of trigger 125. The pins 157 are biased inwardly by biasing element 158, which in one example can be springs. While biasing element 158 is shown as springs, it is within the scope of this disclosure to implement any biasing element, or elastic material.

In FIGS. 4 and 5A, the stabbable tool 100 is shown in the unactuated configuration. In the unactuated configuration, the adjustment end 155 of the elongate stabbing body 115 retracted into and is contained in the pressure chamber mouth 106. The pressure chamber mouth 106 is part of the pressure chamber 147 within the stabbable tool 100 and is in fluidic communication with valve 137. A fluid pathway extends from valve 137 through the bore 151 of hydraulic hose 150 having hydraulic fittings 152, and then the fluid pathway extends through a channel 153 to the pressure chamber mouth 106, all of which form part of the pressure chamber 147 of the stabbable tool 100. When the fitted end 105 is attached to an inlet 20 via a valve (see FIG. 8 below) of the multiport valve 10 (see FIG. 8 below), fluid may pass between the pressure chamber mouth 106 through exit aperture 110 into the inlet 20 until pressure equalizes or until greater pressure is provided from the valve 137. The pins 157 are illustrated as biased inward by biasing elements 158 and may abut against the plunger head 210. Accordingly, when the plunger head 210 is urged forward (by bumper spring 235, shown in FIG. 5B) the ramped surface of the plunger head 210 surface will press against the pins 157 urging them and extending them laterally. Upon actuation of the trigger 125, the plunger is pulled backward and the pins 157 are retracted inward by biasing elements 158.

FIG. 5B illustrates a partial cross-sectional view of the rear end of the stabbable tool 100 of FIG. 4 in the unactuated configuration. As shown, there is a cavity 240 within the pressure compensation cylinder 140. The distal end 305 of the elongate stabbing body 115 extends within cavity 240 abutting or proximate to cylinder end 145. The plunger 200 has a plunger base 225, or piston base, within the outer tubular wall 205 along with a seal 250, and which may also be placed within a bushing. A bumper spring 235 is illustrated at the base of elongate the elongate stabbing body 115, which may alternatively be any type of biasing element. The bumper spring 235 urges the plunger 200 forward to extend the plunger head 210 thereby extending the pins 157 laterally (also shown in FIG. 7A below)

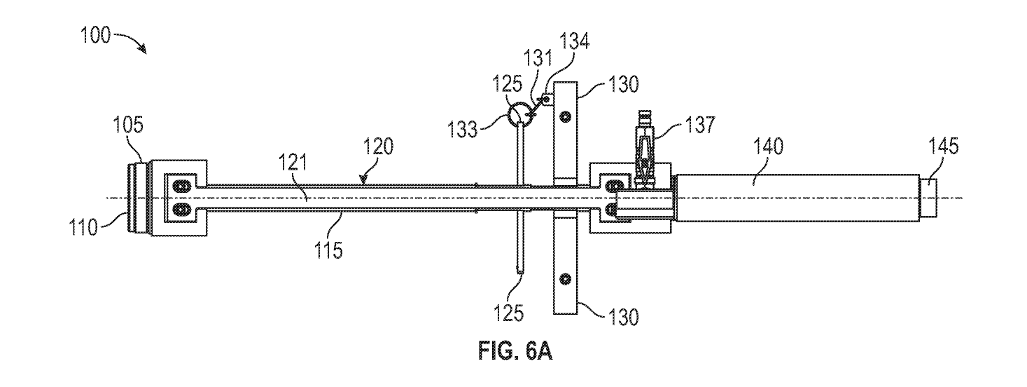

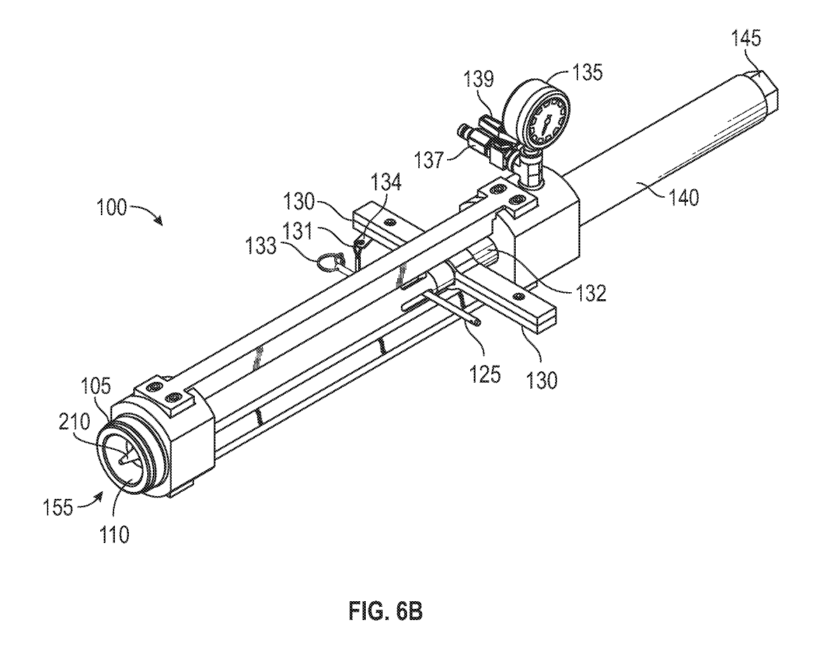

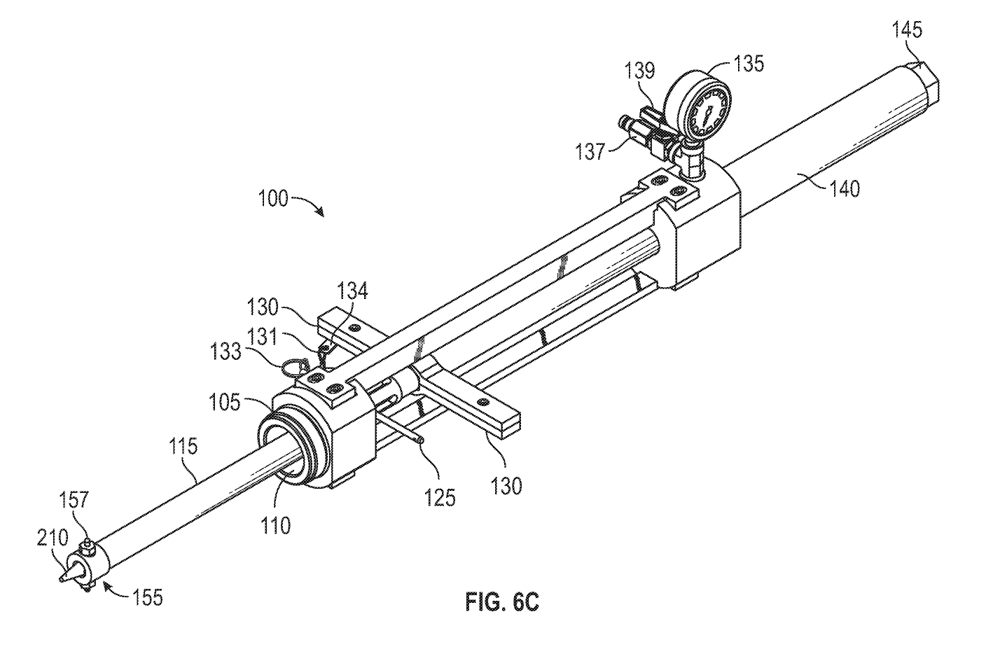

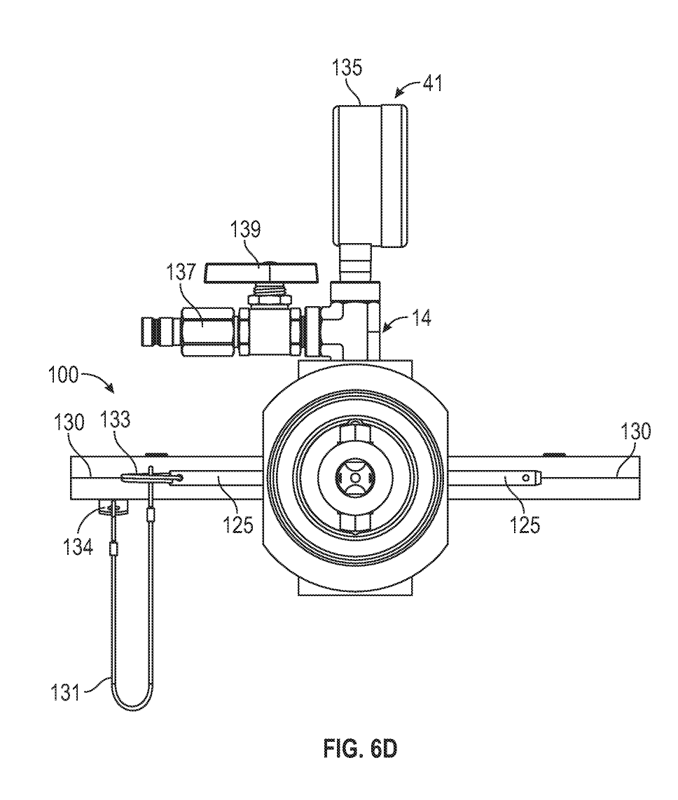

FIG. 6A is a top plan view of the stabbable tool 100. As shown, in this example, handles 130 extend laterally from the elongate stabbing body 115, which is located below the support bar 121. FIG. 6B is a perspective view of the stabbable tool 100, at which angle the valve 137 is shown which may be closed or open via a rotatable handle 139 (which may also be a wing nut). A pressure pump may be coupled with the valve 137 for pressurizing the pressure chamber 147 within the stabbable tool 100. As further shown in FIG. 6B the elongate stabbing body 115 may have a hex portion 132. The handle 130 may have a hex shaped underside corresponding to the hex portion 132. Accordingly, the handle 130 may be shifted forward over the hex portion 132. When engaged, an operator may rotate the handle 130 and due to its resistive engagement with the hex portion 132 the elongate stabbing body 115 will correspondingly rotate along with the engagement end 155 and pins 157 (when extended). After a rotation, the handle 130 may abut one of the upper or lower support bars 121 and/or 121a, and so an operator may move the handle 130 rearward off the hex portion 132, reset and then reengage the handle 130 with the hex portion 132 to further rotate the elongate stabbing body 115. This may be repeated until desired torque is reached and the adjustment nut 50 fully tightened. The hex portion 132 may have any polygonal shape to provide a resistive surface for the handle 130 and may have any number of sides or surfaces, for instance from 2 to 10. The lanyard 131 extending between handle 130 and trigger 125 via ring 133 attached to the trigger 125 and projection 134 which is attached to the handle 130, which is illustrated as a flange, but may be any projection for supporting the trigger 125. When the handle 130 is shifted over hex portion 132 to rotate the elongate stabbing body 115, the trigger 125 may be removed so that it does not interfere with the upper and lower support bars 121 and 121a as the elongate stabbing body is rotated (which may be 360 degree rotation turns). The trigger 125 may hang from the handle 130 when removed so that it is not lost. FIG. 6C illustrates stabbable tool 100 in a projected configuration. The elongate stabbing body 115 has moved from the unactuated configuration in FIG. 6B where the adjustment end 155 having pings 157 and plunger head 210 withdrawn within exit aperture 110 to a projected configuration wherein the adjustment end 155 extends out. FIG. 6D is front view of a stabbable tool 100 further illustrating the trigger 125, handle 130 with set string 131, along with valve 137.

FIGS. 7A and 7B illustrate the stabbable tool 100 in a projected configuration. The elongate stabbing body 115 is slidable to move from a first configuration where the adjustment end 155 is contained within the pressure chamber mouth 106, as shown in FIGS. 4 and 5A, to a projected configuration, for example as shown in FIG. 7A, where the adjustment end 155 is projected through the exit aperture 110 to an extended position outside of the frame 120. In one example, the operation can be performed by pushing handles 130 to slide the elongate stabbing body 115 forward. When the fitted end 105 is coupled with the multiport valve 10 (via a valve as illustrated in FIG. 8), the adjustment end 155 is extended within an inlet 20, and may be used to adjust the adjustment nut 50 (see FIG. 2B). When coupled with the multiport valve 10 (via a valve as illustrated in FIG. 8) a seal is formed between the stabbable tool 100 and the multiport valve 10 and providing fluidic communication between the multiport valve 10 and the pressure chamber 147 of the stabbable tool 100. FIG. 7A shows the pressure chamber 147 extending throughout the frame 120, having a fluid 310 contained therein (illustrated by the texture) extending from the pressure chamber mouth 106, channel 153, bore 151 of the hydraulic hose 150 to the cavity 240 of the pressure compensation cylinder 140.

When the elongate stabbing body 115 is in the projected configuration, the pins 157 are extended laterally from the adjustment end 155. In the illustrated example, the plunger head 210 of plunger 200 is urged forward by the bumper spring 235 thereby extending the pins 157 laterally. The pins 157 may engage the adjustment nut 50 within the multiport valve 10, as discussed above in FIG. 2E. The trigger 125 may be actuated by an operator grasping and pulling or squeezing the trigger 125 thereby withdrawing the plunger 200 and causing the pins 157 to retract. In particular, squeezing trigger 125 retracts plunger 200 further within the tubular wall 205 of the elongate stabbing body 115 which causes the pins 157 to retract by biasing springs 158. When the trigger 125 is again released, the plunger 200 extends forward and the plunger head 210 urges the pins 157 to extend laterally overcoming the strength of the biasing springs 158. The elongate stabbing body 115 is then rotatable by the handle 130 to tighten the adjustment nut 50.

As illustrated in FIG. 8, the stabbable tool 100 may be coupled with the multiport valve 10 via a coupling assembly 800. The coupling assembly 800 includes a ball valve 810. The ball valve 810 includes a handle 812 which may be actuated to open and close the ball valve 810 thereby opening or closing access for fluidic communication with the multiport valve 10, so as to act as a vent release. Alternatively, the ball valve 810 may be any type of valve which may be actuated to open and close fluidic communication into an inlet 20 of the multiport valve 10. A nipple 805 is further coupled with the ball valve 810 to provide sealed fluidic communication from the inlet 20 to the ball valve 810. The nipple 805 may alternatively be any type of coupling to form a seal with the ball valve, such as a flange.

As shown the fitted end 105 coupled with the ball valve 810, which may have a threaded portion to receive and couple with the fitted end 105. The elongate stabbing body 115 is shown in the projected configuration where the adjustment end 155 has been extended out of the pressure chamber mouth 106 and through the exit aperture 110, ball valve 810, nipple 805 and into the inlet 20 to reach the adjustment nut 50. The adjustment end 155 operates on the adjustment nut 50 for example by rotating the adjustment nut 50 to tighten and reset the springs in the portseal assembly (as shown in FIG. 2E). The handle 130 may be used by an operator to rotate the elongate stabbing body 115 in the frame 120. A window 320 may be provided to help the operator locate the interior slots of the adjustment nut 50. After adjustment has been made, the operator may then actuate the trigger 125 to retract the pins 157 and then withdraw the elongate stabbing body 115 from the projected configuration to the unactuated configuration as illustrated in FIGS. 3-6B. The valve 137 (shown in FIG. 4) may then be opened to vent pressure from within the chamber 147. The ball valve 810 may then be closed and a plug coupled with the ball valve 810 until adjustment of the portseal assembly 42 is again required.

The stabbable tool 100 may have permanent or semi-permanent installed component and a removable component. This facilitates periodic use of the stabbable tool 100 with the multiport valve 10. For instance, the coupling assembly 800 having the nipple 805 and ball valve 810 may be coupled with the multiport valve 10 on a permanent or semi-permanent basis. For instance, the coupling assembly could be made as integral components with the multiport valve 10, or welded on, or attached via threaded engagement. A plug (not-shown) could be placed to cover the ball valve 810 when not in use and may contain a gage for indicating pressure within the multiport valve 10. When an operator wishes to adjust the portseal assembly 42 and access the adjustment nut 50, the plug would first be removed and then the removable component would be installed. The removable component includes the stabbable tool 100. For instance, multiport valves in the field may be fitted with the coupling assembly 800 for later coupling with the stabbable tool 100 when adjustment is required. Alternatively, multiport valves may be provided with the coupling assembly 800 already installed. While the stabbable tool 100 is discussed herein with respect to the multiport valve 10, the stabbable tool 100 may be used with any pressure vessel.

The examples shown and described above are only examples. Many details are often found in the art such as the other features of a logging system. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure to the full extent indicated by the broad general meaning of the terms used in the attached claims. It will therefore be appreciated that the examples described above may be modified within the scope of the appended claims.

1. An adjustment tool for a pressure vessel comprising:
an elongate frame having
a fitted end with an exit aperture,
a pressure chamber in fluidic communication with the exit aperture, the fitted end sealingly couplable with the pressure vessel to form sealed fluidic communication between the pressure vessel and the pressure chamber through the exit aperture,
a pressure valve actuable to open and close fluid flow from the pressure chamber to outside the elongate frame, and
a bore; and
an elongate stabbing body slidable and rotatable within the bore and having an adjustment end, the elongate stabbing body slidable within the bore between a first unactuated configuration where the adjustment end and is contained within the pressure chamber through the exit aperture to a second projected configuration wherein the adjustment end is extended outside the elongate frame and into the pressure vessel when the fitted end is coupled with the pressure vessel.

2. The adjustment tool of claim 1, further comprising a pressure compensation cylinder coupled with the elongate frame and in fluidic communication with the pressure chamber.

3. The adjustment tool of claim 2, wherein the elongate stabbing end having a distal end opposite the adjustment end, the distal end being contained in the compensation cylinder when the adjustment end is in the first unactuated configuration.

4. The adjustment tool of claim 1, wherein the fitted end is couplable with a coupling valve of a multiport valve forming fluidic communication between the adjustment tool and the multiport valve.

5. The adjustment tool of claim 1, wherein the pressure valve is a ball valve.

6. The adjustment tool of claim 1, wherein the adjustment end has a pin extendable laterally from the elongate stabbing body.

7. The adjustment tool of claim 6, wherein a biasing element urges retraction of the pin.

8. The adjustment tool of claim 7, further comprising a trigger wherein upon actuation the pin is retracted and upon release of the trigger the pin is extended laterally.

9. The adjustment tool of claim 8, further comprising a plunger within the elongate stabbing body, wherein upon actuation of the trigger the plunger is withdrawn within the elongate stabbing body thereby retracting the pin and upon release of the trigger the plunger is extended thereby extending the pin laterally.

10. The adjustment tool of claim 1, wherein the bore of the elongate frame has a seal encircling the elongate stabbing body preventing fluid flow from the pressure chamber.

11. The adjustment tool of claim 10, wherein the seal comprises a plurality of O-rings.

12. The adjustment tool of claim 1, further comprising a handle extending laterally from the elongate stabbing body to facilitate rotation of the elongate stabbing body.

13. A system comprising:
an elongate frame having
a pressure chamber,
a fitted end with an exit aperture, the fitted end sealingly coupled with a pressure vessel to form sealed fluidic communication between the pressure vessel and the pressure chamber within the elongate frame through the exit aperture
a pressure valve actuable to open and close fluid flow from the pressure chamber to outside the elongate frame,
a bore; and
an elongate stabbing body slidable and rotatable within the bore and having an adjustment end, the elongate stabbing body slidable within the bore from a first unactuated configuration where the adjustment end and is contained within the pressure chamber through the exit aperture to a second projected configuration wherein the adjustment end is extended outside the elongate frame and into the pressure vessel when the fitted end is coupled with the pressure vessel.

14. The system of claim 13, wherein the pressure vessel is a multiport valve having a plurality of inlets, a common outlet and test outlet.

15. The system of claim 13, further comprising a pressure compensation cylinder coupled with the elongate frame and in fluidic communication with the pressure chamber.

16. The system of claim 15, wherein the elongate stabbing end having a distal end opposite the adjustment end, the distal end being contained in the pressure compensation cylinder when the adjustment end is in the first unactuated configuration.

17. The system of claim 13, wherein the adjustment end has a pin extendable laterally from the elongate stabbing body.

18. A method comprising:
coupling a fitted end of an elongate frame to a multiport valve, the frame having a pressure chamber and the fitted end having an exit aperture, the coupling forming a seal and permitting fluidic communication between the multiport valve and the pressure chamber through the exit aperture; and
an elongate stabbing body slidable and rotatable within a bore of the elongate frame and having an adjustment end, the elongate stabbing body slidable within the bore from a first unactuated configuration where the adjustment end and is contained within the pressure chamber through the exit aperture to a second projected configuration wherein the adjustment end is extended outside the elongate frame and into the multiport valve when the fitted end is coupled with the pressure vessel;
rotating the adjustment end within the multiport valve.

19. A multiport valve comprising:
a plurality of inlets;
a common outlet in fluidic communication with the plurality of inlets;
a test outlet;
an inlet port selector rotor rotatable to divert fluid from one of the plurality of inlets to the test outlet, the inlet port selector rotor having a biasing element and an adjustment nut, wherein upon rotation of the adjustment nut the biasing element is reset; and
a coupling assembly coupled to at least one of the plurality of inlets, said coupling assembly having a valve for vent release.

20. The multiport valve of claim 19 further comprising a stabbable tool comprising:
an elongate frame having
a fitted end with an exit aperture,
a pressure chamber in fluidic communication with the exit aperture, the fitted end sealingly couplable with the coupling assembly to form sealed fluidic communication between the multiport valve and the pressure chamber through the exit aperture,
a pressure valve actuable to open and close fluid flow from the pressure chamber to outside the elongate frame, and
a bore; and
an elongate stabbing body slidable and rotatable within the bore and having an adjustment end, the elongate stabbing body slidable within the bore between a first unactuated configuration where the adjustment end and is contained within the pressure chamber through the exit aperture to a second projected configuration wherein the adjustment end is extended outside the elongate frame and into the multiport valve when the fitted end is coupled with the coupling assembly.

21. A multiport valve further comprising a stabbable tool removably couplable with a coupling assembly of the multiport valve, the stabbable tool comprising
an elongate frame having
a fitted end with an exit aperture,
a pressure chamber in fluidic communication with the exit aperture, the fitting end sealingly couplable with the coupling assembly to form sealed fluidic communication between the multiport valve and the pressure chamber through the exit aperture,
a pressure valve actuable to open and close fluid flow to the pressure chamber from outside the elongate frame,
a bore; and
an elongate stabbing body slidable and rotatable within the bore and having an adjustment end, the elongate stabbing body slidable within the bore from a first unactuated configuration where the adjustment end and is contained within the pressure chamber through the exit aperture to a second projected configuration wherein the adjustment end is extended outside the elongate frame to engage an adjustment nut when the fitted end is coupled with the coupling assembly of the multiport valve.
